(19) United States
(12) Patent Application Publication
(10) Pub. No.: US 2007/0064593 A1
(43) Pub. Date: Mar. 22, 2007

(54) Method and system for automatically resetting a cable access module upon detection of a lock-up

(76) Inventors: Tim Scale, Downers Grove, IL (US); Greg Gohman, Hoffman Estates, IL (US); Dmitri Fridman, Lisle, IL (US); Alan Doucette, Naperville, IL (US); Paul Fischer, Downers Grove, IL (US); John Pokropinski, Woodridge, IL (US); John Dougherty, Aurora, IL (US); Jim Allen, Naperville, IL (US)

Correspondence Address: ARRIS INTERNATIONAL, INC, 3871 LAKEFIELD DRIVE, SUWANEE, GA, 30024, US

(21) Appl. No.: 11/515,302

(22) Filed: Sep. 1, 2006

Related U.S. Application Data
(60) Provisional application No. 60/713,539, filed on Sep. 1, 2005.

(51) Int. Cl. H04L 12/26

(52) U.S. Cl. 370/216

(57) ABSTRACT

A Cable Access Module is periodically monitored to detect lock-up condition on an upstream channel. Traffic activity on an upstream channel of the CAM is compared to predetermined criteria to determine lock-up. If CMs are detected being coupled to the CAM, a PING message is sent to a group of CMs. If the PING is not acknowledged, a round robin counter is used to cycle through modems sending PINGs thereto. If no PINGs are acknowledged, the CAM is deemed satisfactory if upstream bytes over the upstream channel are detected. If not, an escalating maintenance subroutine implements corrective action of increasing magnitude during based on a recovery count variable that increments with each successive pass before returning to the monitor period parent routine. If CMs were detected as coupled to the CAM, but some data has been passed over the upstream channel being evaluated, the escalating maintenance subroutine is invoked.

### CROSS REFERENCE TO RELATED APPLICATION

This application priority under 35 U.S.C. 119(e) to U.S. provisional patent application No. 60/713,539 entitled “Method and system for detecting lock-ups in a cable modem termination system communication network,” which was filed Sep. 1, 2005, and is incorporated herein by reference in its entirety.

### FIELD OF THE INVENTION

The present invention relates generally to communication devices, and more particularly to automatically detecting and resetting a cable modem termination system upon detection of a lock-up condition.

### BACKGROUND

Cable data systems are used to allow cable TV subscribers to use the Hybrid-Fiber-Coax network as a communication link between their home networks and the Internet. As a result, computer information (Internet Protocol packets) can be transmitted across the Hybrid-Fiber-Coax network between home computers and the Internet. The DOCSIS specification (defined by CableLabs) specifies the set of protocols that must be used to effect a data transfer across the Hybrid-Fiber-Coax network. Two fundamental pieces of equipment permit this data transfer: a cable modem (CM) which is positioned in the subscriber's home, and a Cable Modem Termination System (CMTS) which is positioned in the head end of the cable TV company.

In addition to data traffic, subscribers are more and more obtaining telephony voice services over networks other than the traditional public switched telephony network (“PSTN”). A multiple services operator (“MSO”) may provide such telephony services, in addition to data over cable service via DOCSIS. For example, CableLabs has established the PacketCable standard for providing telephony services over cable. A subscriber typically has a device that includes a DOCSIS cable modem for transmitting and receiving data and a media terminal adaptor (“MTA”) for processing voice traffic for transmission and reception over cable. The MTA, or embedded MTA (“EMTA”) known in the art, typically provides signals received from the cable network to the plain old telephone service (“POTS”) network in a user's home or office.

As with most complex electrical systems and equipment, a cable modem termination system is prone to becoming inoperable for a variety of reasons. For example, the card, or blade as referred to in the art, located at the CMTS that subscriber devices are coupled to may freeze, or lock-up, and cease operating normally. A customer recognizes this because service to his or her subscriber device stops working. If the subscriber is browsing the internet or sending e-mail, web pages may not be accessible or e-mail messages may not be delivered. If the subscriber is using a cable modem EMTA to carry telephony calls, the call may be dropped.

When a subscriber/user loses service, he or she does not know what caused the loss. However, a variety of scenarios can cause a freeze condition. For example, noise induced into an upstream channel, which is typically more susceptible to noise that downstream channels, can cause unrecognized information to arrive at the CAM, thus causing it to lock-up, or freeze. Or, if a user device, such as a computer, causes unrecognized information to be sent to the CAM, the CAM can freeze.

When a subscriber notices that service is not available, the subscriber may call the service provider using a telephone device and complain. This process may involve waiting for an available service representative. Furthermore, if the customer receives data, voice and video service from the same provider, a call to the provider may not be possible, since the call traffic would be directed to the locked-up CMTS blade.

Assuming that the customer/user/subscriber reaches a service representative, the service representative may check to determine where the problem lies. If it is determined that a blade, or cable access module (“CAM”) card, is not functioning, the service provider personnel may remotely send a message to the CMTS that resets the CAM card. Resetting typically involves removing power to the ‘frozen’ card and rebooting it. When this occurs, the user (or multiple users, since typically multiple users are coupled to a single CAM) waits until the CAM reboot process completes, which may take a few minutes.

Thus, there is a need in the art for a method and system that automatically detects when a CMTS blade is frozen, locked-up or otherwise inoperable. There is also a need for a method and system for automatically correcting the inoperable condition. In addition, there is a need for a method and system for providing the minimum corrective action needed to correct the inoperable condition so as to reduce time to operability.

### BRIEF DESCRIPTION OF THE DRAWINGS

FIG. 1 illustrates a system for providing broadband access through a interface module.

FIG. 2 illustrates a system for acquiring data related to upstream and downstream broadband traffic.

FIG. 3 illustrates a flow diagram of a parent routine for launching a routine to detect lock-up of a broadband interface module.

FIG. 4 illustrates a flow diagram of a routine for assessing the potential that a lock-up conditions exists in a broadband interface module.

FIG. 5 illustrates a flow diagram of a routine for further assessing the potential that a lock-up conditions exists in a broadband interface module.

FIG. 6 illustrates a flow diagram of an escalating maintenance routine for resetting a broadband interface module when a lock-up condition exists.

### DETAILED DESCRIPTION

As a preliminary matter, it will be readily understood by those persons skilled in the art that the present invention is susceptible of broad utility and application. Many methods, embodiments and adaptations of the present invention other than those herein described, as well as many variations, modifications, and equivalent arrangements, will be apparent from or reasonably suggested by the present invention and the following description thereof, without departing from the substance or scope of the present invention. It will be appreciated that the routines described herein may be implemented as executable software loaded an operating and/or operating in and/or on a broadband central device, such as a CMTS, at a service provider's head end location. In addition, the routines described herein may also be implemented in hardware or firmware.

Accordingly, while the present invention has been described herein in detail in relation to preferred embodiments, it is to be understood that this disclosure is only illustrative and exemplary of the present invention and is made merely for the purposes of providing a full and enabling disclosure of the invention. This disclosure is not intended nor is to be construed to limit the present invention or otherwise to exclude other embodiments, adaptations, variations, modifications and equivalent arrangements, the present invention being limited only by the claims appended hereto and the equivalents thereof.

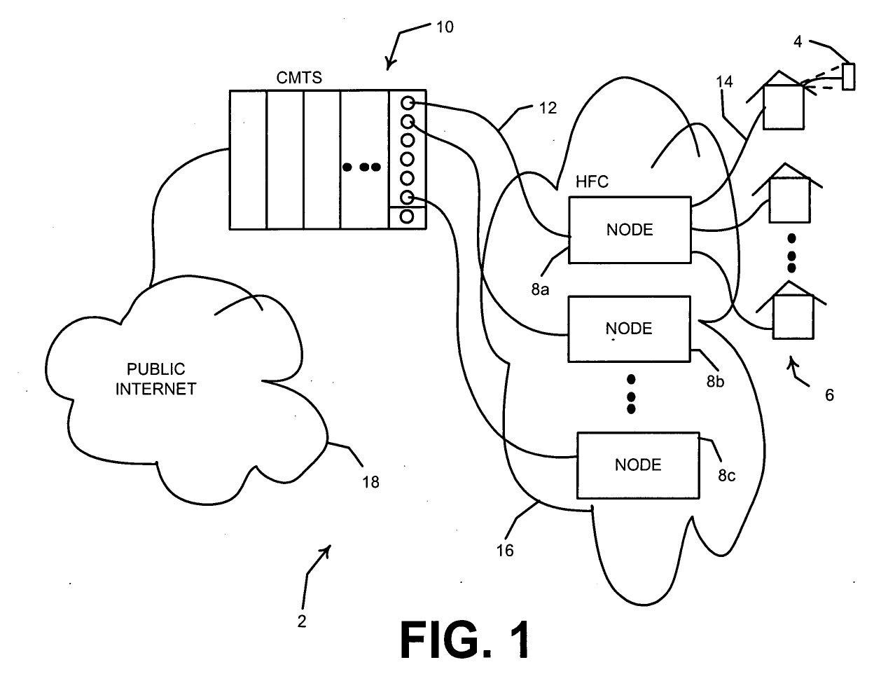

Turning now to FIG. 1, a system 2 is shown for providing broadband service to/from a plurality of subscriber devices 4 at a corresponding plurality of subscriber/user locations 6. Subscriber devices 4 are connected to nodes 8 which are coupled to a CMTS 10. Nodes 8 coupled to CMTS 10 typically over fiber cables 12 and subscriber devices typically are connected to the nodes via coaxial links 14. Links 12 and 14, along with nodes 8 compose what is typically referred to in the art as a hybrid fiber coaxial (“HFC”) network 16. CMTS 10 typically couples to the internet 18 via Ethernet connections. It will be appreciated that each node 8 connects to multiple subscriber devices 4, which are typically cable modems, but the maximum number of cable modems that may be connected to a node is not shown in the figure for clarity. Furthermore, for purposes of discussion, the aspects described herein relate to the upstream direction—signal flow from user device 4 to CMTS 10. Therefore, links 12 represent upstream channels. Downstream channels, which typically propagate on the same physical link as upstream channels, are not shown for clarity.

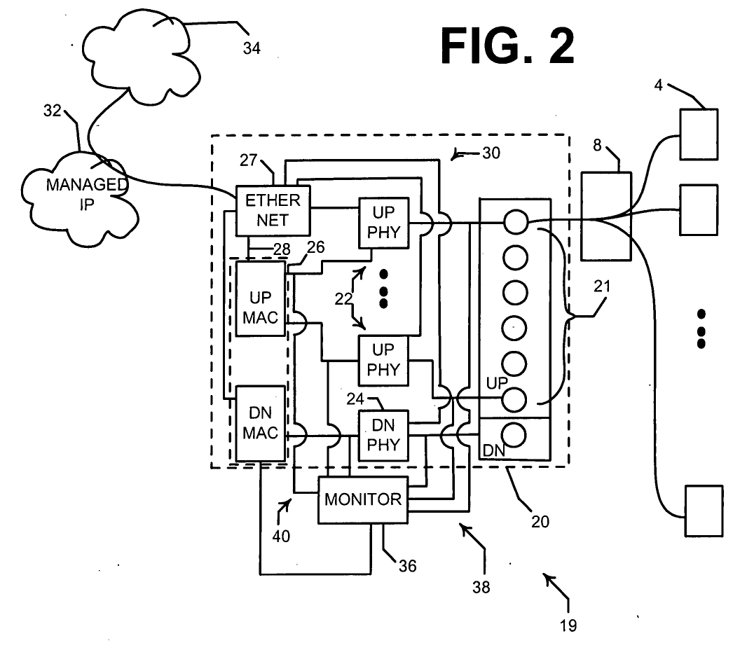

Turning now to FIG. 2, a system 19 for detecting when a CMTS blade 20 is not operational is shown. Upstream traffic messages are processed by physical layer interface portions (PHY) 22. For perspective, downstream PHY 24 is shown. PHYs 22 and 24 are controlled by media access control portion (“MAC”) 26, which may receive upstream control messages from Ethernet interface 27 over upstream Ethernet control link 28. PHYs 22 and 24 may receive control message from Ethernet interface 27 via control links 30. Control messages may be received from a managed IP network 32, which may receive control signals from the internet 34. Various metrics can be monitored by monitor 36, which is coupled to the input and output of upstream PHYs 22 via links 38 and 40 respectively. It will be appreciated that monitor 36 is shown as a physical block in the figure, but may be implemented as a state machine, or a finite state machine (“FSM”), as referred to in “Data-Over-Cable-Service-Interface Specifications; Modular-CMTS; Edge Resource Manager Interface Specification; CM-SP-ERMI-I02-051209.” A state machine may be built using hardware, or software, as known in the art. Other implementations for monitoring, storing and providing as an output the metrics may also be implemented that perform the same function, in the same way with the same result as a state machine.

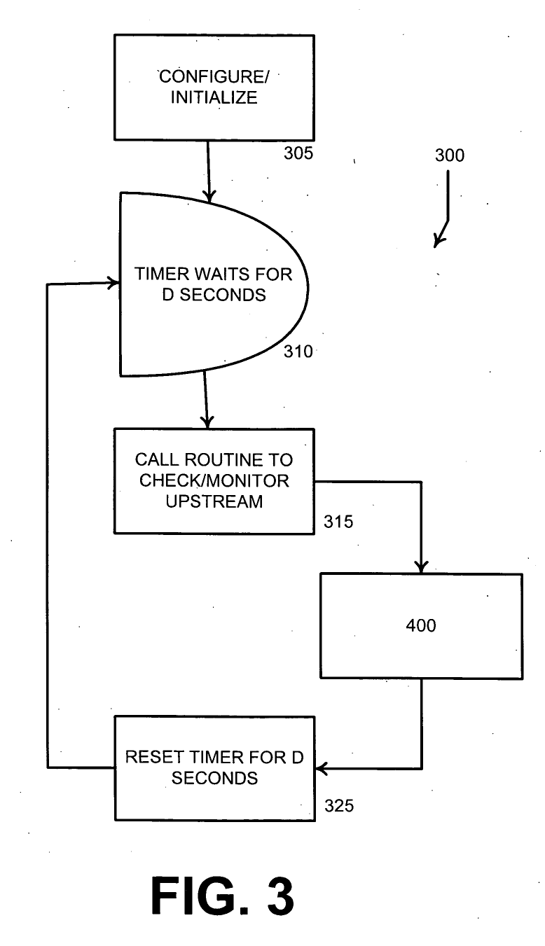

Turning now to FIG. 3, the figure illustrates a flow diagram of a method 300 for determining when to monitor a broadband interface module for a lockup condition. The broadband interface module may include CMTS interface module located at a service provider's head end location. At step 305 variables that may be used in method 300 and that may be passed from method 300 to one or more subroutines are initialized. For example, variable, herein named Threshold (“TH”), Delay (“D”), Recovery (“R”) and Enable (“E”) are initialized. The TH variable stores the number of registered cable modems that trigger a call to a subroutine that monitors for a lockup condition. The D variable is a value representing a period to wait before calling the monitoring subroutine. The R variable is a selectable Boolean variable. When evaluated, if R is true, corrective action may be invoked to recover a locked-up broadband interface module. The E variable is also a selectable Boolean variable. When evaluated, if E is true, a monitoring subroutine may be executed.

At step 310 a timer counts down for a period equal to D. When the timer has counted from D to zero (or from zero to D), a call at step 315 to subroutine 400 is made. Subroutine 400 will be described in detail later. When control returns from subroutine 400, a new timer count is initialized and control returns to step 310. It will be appreciated that routine 300, subroutine 400 and other subroutines herein described may be implemented in the software programs that control and operate a communications network central device, such as, for example, a CMTS at a MSO-operated head end. However, other embodiments may include human performance of some of the steps herein described, for example, of corresponding steps in some aspects.

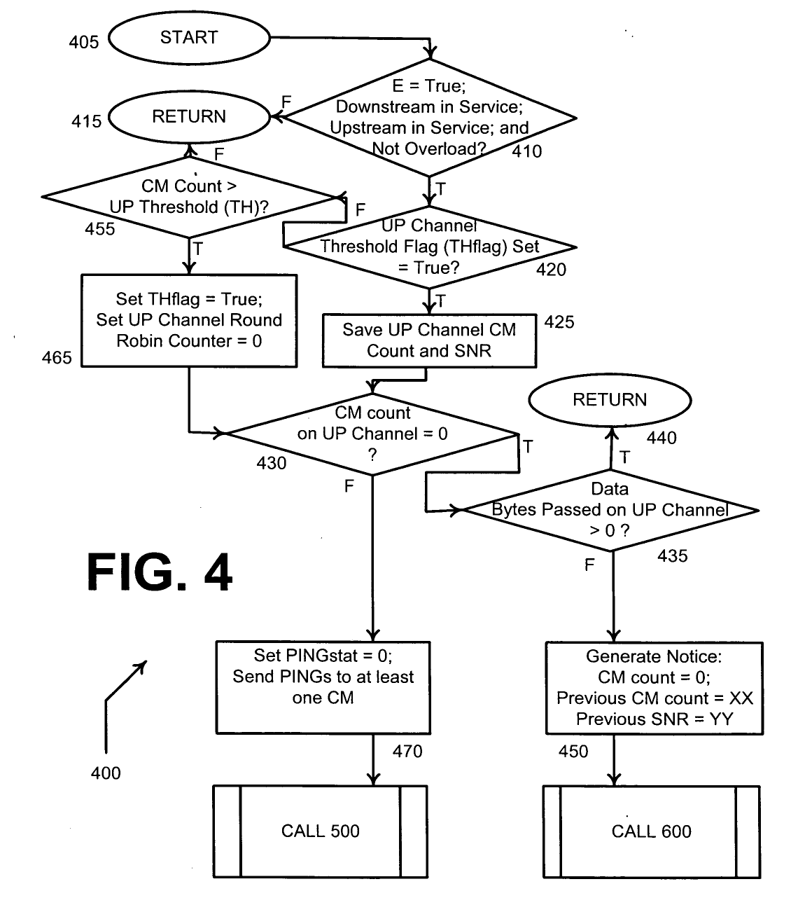

Turning now to FIG. 4, a flow diagram of a method 400 for monitoring a broadband interface module is illustrated. Subroutine 400 starts at step 405 when called from routine 300. At step 410, criteria are evaluated to determine whether to monitor a given broadband interface module. Step 410, as well as other steps in routines described herein, may be referred to as a state machine as known in the art. A state machine may be implemented in hardware, firmware and/or software as known in the art. Furthermore, other steps that may not be implemented as state machines may also be implemented in hardware, firmware and/or software.

At step 410, a determination is made whether all of four criteria are true. If not, process 400 advances to step 415 and control of the process that monitors and determines whether to take action to correct a lockup condition of an interface module returns to step 325 shown in FIG. 3. Continuing with discussion of FIG. 4, the four criteria evaluated include determining whether E is true, whether a downstream channel of the interface module is in service, whether an upstream channel of the interface module is in service and whether the interface module, or modules that make up a system of interface modules, are processing a high level of traffic signals. It will be appreciated that the level of traffic being processed is typically evaluated vis-a-vis a predetermined bandwidth level.

If E=True, and if a downstream channel coupled to the broadband interface module under evaluation is in service, and if at least one upstream channel on the same interface module is in service and if the module is not in an overload condition, method 400 advance to step 420. At step 420, a determination is made whether an upstream threshold variable THflag, which has a default value of false, has been set to true. If THflag evaluates as true at step 420, the number of cable modems that are coupled and registered (a value ‘known’ to the CMTS operating system) to the upstream channel under evaluation is saved at step 425. The signal to noise ratio of the upstream channel under evaluation is also stored at step 425. It will be appreciated that these values may be stored to a memory coupled to the state machine or other device that performs the steps described herein.

After the count of the number of registered cable modems on the upstream channel under evaluation has been stored, and the signal to noise ratio of the channel under evaluation has been stored, a determination is made at step 430 whether the number of cable modems operably coupled, i.e., registered, to the upstream channel under evaluation is zero. If zero, then the determination is made at step 435 whether an amount of data greater than zero has passed from a cable modem to the interface module, a condition that may occur if a modem is unable to register (the DHCP server is inoperable, for example) but the upstream channel at the broadband interface module may be operational. This determination would be based on a information acquired since the previous call to routine 400 was at step 315 shown in FIG. 3. If the amount of data passed since the last iteration/pass is greater than zero, routine 400 returns to parent routine 300 at step 440. If however, the amount of data passed since the last iteration of routine 400 is not greater than zero, then method 400 advances to step 450. At step 450, a message string is generated that states to the effect “Modem count zero, Previous modem count XX, Previous signal to noise (“SNR”) was YY.” It will be appreciated that this recitation is given as an example of a message string that may be generated, but that an actual message need not be the exact context and syntax as just here stated. Furthermore, the message may not be a text string message, but may be a table of data, or a code that indicates that the amount of upstream data passed from the modems connected to the upstream channel of the interface module is less than during a previous iteration/pass through method 400, and that passes the values of previous data amount and SNR. After the message string has been generated at step 450, routine 400 calls subroutine 600, which will be discussed in detail later.

Returning to description of action at step 420, if THflag is set to true, a determination is made at step 455 whether the number of cable modems registered with the interface module is greater than the value TH. If the number of cable modems registered with the interface module does not exceed the threshold value TH, then the routine 400 advances to step 415 and returns to step 325 of method 300 shown in FIG. 3.

If the number of cable modems registered with the interface module under evaluation is determined at step 455 to be greater than TH then THflag is set to equal true at step 465. Also at step 465 an upstream channel round robin counter (“UpRRC”) is set to zero and method 400 continues on to step 430.

If the number of cable modems registered is not equal to zero, as determined at step 430, then a PING process is initialized at step 470. At step 470, a variable named PINGstat is set to zero and a PING message is sent to a group of cable modems coupled to the upstream channel under evaluation. A PING message typically includes a message sent to a device requesting that the device return an acknowledgement message to the device that sent the PING message. An acknowledgement indicates to the sending device that the receiving device is operable. A typical initial group of cable modems includes one or two cable modems, although a group could comprise three or more cable modems. The round robin counter is used to sequentially send PING messages to the modems in the group. Next, Ping function subroutine 500 is called.

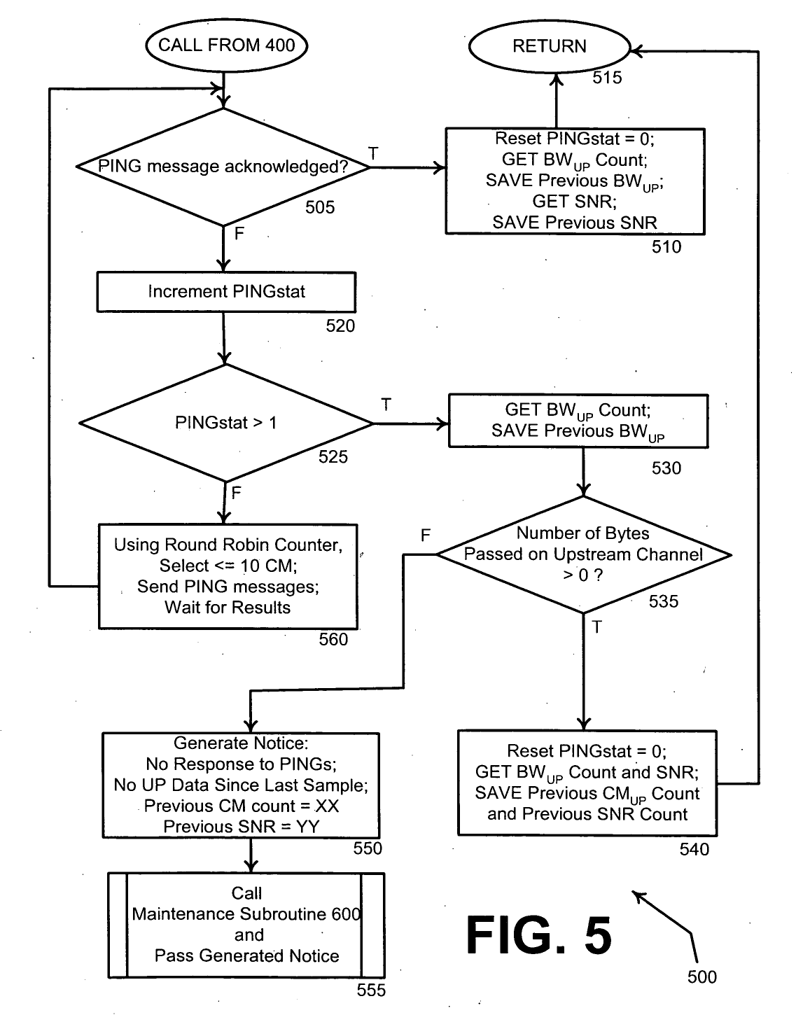

Turning now to FIG. 5, a flow diagram illustrating ping function 500 is illustrated. At step 505, a determination is made whether the PING message was acknowledged by any of the modems in the group to which the PING message(s) has been sent. If so, PINGstat is set to zero at step 510. Also at step 510, other information is stored. This information includes current bandwidth usage count for the upstream channel under evaluation as well as the previous upstream channel usage count for the same channel. In addition, the current SNR is saved as well as the previous SNR measurement for the same channel. Subroutine 515 returns to step 325 shown in FIG. 3. Continuing with discussion of FIG. 5, if a determination is made at step 505 that an acknowledgement of the PING message is not received, PINGstat is incremented at step 520. Next, at step 525 a determination is made whether PINGstat is greater than one. If PINGstat is greater than one, then two sets of PING messages have not been acknowledged twice in a row. At step 530 a the current upstream channel bandwidth usage count is retrieved and stored as is the value of the previous measurement of upstream channel bandwidth usage. At step 535, a determination is made whether any bytes have passed on the upstream channel under evaluation since the last measurement of bandwidth usage based on the values stored at step 530.

The passage of some bytes indicates that the upstream channel is operational. PINGstat is reset to 0 at step 540, at which step current and previous bandwidth usage values are store as well as current and previous SNR values. Subroutine 500 returns to step 325 shown in FIG. 3 at step 515. If a determination is made at step 535 that no bytes have passed from any cable modems since the last measurement was made, a notice message is generated at step 550 indicating that “PINGs to CM failed, no upstream data since last sample, previous count was XX, previous SNR was YY.” As discussed earlier with respect to the message generated at step 450, the format and wording may deviate from the message herein described, but the an indication that the PING'ed cable modems failed to respond and a reporting of the previous bandwidth/byte count and previous SNR is passed. This information in the message generated at step 550 is passed at step 555 to subroutine 600, which will be described later.

Continuing with discussion of FIG. 5, if a determination is made at step 525 that the variable PINGstat is not greater than 1, the round robin counter is used to PINGing another group of cable modems. This time, the group may be selected to include more than two or three modems, which was the case with respect to the number of modems in the group to which the first PING was sent at step 470 shown in FIG. 4. The round robin counter may be used to PING modems in the group, which preferably comprises ten or less modems. After the PING message is sent at step 560, routine 500 returns to step 505 and waits for a response from the modems in the current group.

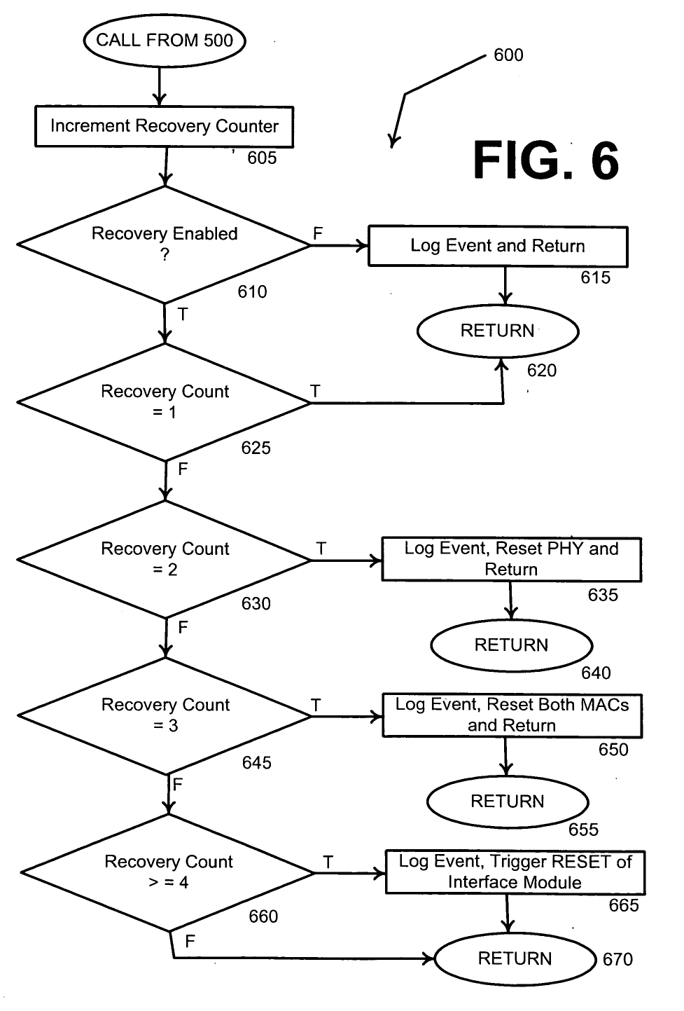

Turning now to FIG. 6, a flow diagram is shown that illustrates escalating corrective action recovery algorithm 600 that may be called from subroutine 500 as discussed above. At step 605, a recovery counter associated with the interface module is incremented. The recovery counter is not reset until the interface module is rest. Resetting the PHY interface or the MAC interface(s) of the interface module does. not reset the recovery counter.

At step 610, a determination is made whether a Boolean variable to enable recovery is set to ‘enable.’ It will be appreciated that this is a different variable from the ‘E’ variable that is initialized at step 305 in FIG. 3. If it is determined at step 610 that the recovery enable variable is not set to ‘enable,’ then the event is logged at step 615 and subroutine returns to step 325 shown in FIG. 3. Event being logged is the condition indicated by the message generated at step 450 shown in FIG. 4 or the condition indicated by the message generated at step 550 shown in FIG. 5, either or which step leads to step 605 shown in FIG. 6. It will also be appreciated that Logging an event typically entails printing or displaying the upstream channel number under evaluation, the previous SNR, the previous cable modem count, the recovery count and various hardware information associated with the interface module corresponding to the upstream channel under evaluation.

Returning to the description of the determination made at step 610, as shown in FIG. 6, if a determination is made that the recovery enable variable is set to ‘enable’ recovery, routine 600 advances to step 625. At step 625, a determination is made whether the recovery count value is equal to one. If so, routine advances to steps 615 and operates as described above in reference to steps 615 and 620.

If at step 625 a determination is made that the recovery count value is not equal to one, routine 600 advances to step 630. At step 630, a determination is made whether recovery count value is equal to two. If so, the condition associated with either steps 450 or 550 is logged at step 635, as discussed above, and a command is caused to be generated and executed by an on-board interface module processor/controller to reset the PHY associated with the upstream channel under evaluation. Then, routine 600 returns to step 325 shown in FIG. 3.

If a determination is made at step 630 that the recovery count value is not 2, then a determination is made at step 645 whether the recovery count value is equal to three. If so, the condition associated with either steps 450 or 550 is logged at step 650, as discussed above, and a command is caused to be generated and executed by an on-board interface module processor/controller to reset both upstream and downstream MACs of the interface module having the upstream channel being evaluated. Then, routine 600 returns to step 325 shown in FIG. 3.

If a determination is made at step 645 that the recovery count value is not equal to three, then a determination is made at step 660 whether the recovery count value is equal to four. If so, the condition associated with either step 450 or 550 is logged at step 665, as discussed above, and a command is caused to be generated and executed by an on-board interface module processor/controller to reset the entire interface module associated with the upstream channel under evaluation. Then, routine 600 returns to step 325 shown in FIG. 3.

Thus, escalating maintenance routine 600 escalatingly applies corrective action to the interface module based on recovery count value; the higher the recovery count variable value, the higher the more drastic the reset action the routine causes to occur.

In addition to causing a reset of the interface card at step 665, the command generated at step 665 may also include an instruction that all cable modems coupled to the CAM card in question be decoupled there from and coupled to a spare CAM card of the CMTS 10 shown in FIG. 1. A spare CAM card may be used for temporarily processing traffic to/from cable modems 6 coupled to node 8, which is served by the CAM card interface module in question, which, for purposes of discussion is card 20 shown in FIG. 2. Use and operation of a spare CAM card is shown and described in U.S. Pat. No. 6,662,368, entitled “Variable Spare Circuit Group Size and Quantity having Multiple Active Circuits,” which is incorporated herein by reference in its entirety.

After the instruction to reset the CAM card interface module and swap cable modems to a spare CAM (if this feature is used) is generated, method 600 advances to step 670 and returns to step 325 shown in FIG. 3. It will be appreciated that at step 660, a recovery count value of four is used to minimize the time between determining that a problem may exist and reset of the CAM card, thus minimizing the amount of time that a subscriber is without a connection. However, the value may be set higher that 4 of an operator often experiences ‘false alarms’, for example if burst of noise are often induced into the operator's HFC plant, thus causing a temporary lock-up condition that may resolve after a noise burst has passed. Furthermore, it will be appreciated that the sequence illustrated in FIG. 6 shows an aspect of corrective action/recovery from a locked-up, or frozen, upstream channel in a interface module, such as, for example, a CAM card. However, for example, the recovery count number values compared at steps 625, 630, 645, and 660 may be set to different values than the ones described. In addition, instead of first resetting a PHY and then resetting a MAC after the next wait period D in FIG. 3, routine 600 may reset just the upstream MAC if recovery count equals 1. Many other combinations of resetting components and an interface module may be performed based on characteristics of the actual network in which the interface module is operating to minimize out-of-service time to subscribers.

These and many other objects and advantages will be readily apparent to one skilled in the art from the foregoing specification when read in conjunction with the appended drawings. It is to be understood that the embodiments herein illustrated are examples only, and that the scope of the invention is to be defined solely by the claims when accorded a full range of equivalents.

What is claimed is:

1. A system for detecting a lock-up condition of a broadband interface module having a physical layer interface component, comprising:
means for monitoring upstream channels coupled to the broadband interface module to obtain metrics corresponding to traffic signals received at the broadband interface module;
means for evaluating the obtained metrics to determining whether traffic received over the monitored channels indicates that the broadband interface module is locked-up; and
means for escalatingly resetting portions of the interface module if evaluating the metrics indicates that the broadband interface module may be locked up.

2. The system of claim 1 wherein the means for monitoring includes a counter that counts the number of packets received at an input to a physical layer component interface of the interface module.

3. The system of claim 1 wherein the means for evaluating includes a means for comparing the metrics corresponding to received packets with predetermined criteria.

4. The system of claim 1 wherein the predetermined criteria is a predetermined packet rate.

5. The system of claim 3 wherein the monitoring means is coupled to a MAC corresponding to the interface module.

6. The system of claim 5 wherein the predetermined criteria is met if a MAC message passes through a physical layer component.

7. The system of claim 1 wherein the means for monitoring includes a round robin counter used for sequentially sending PING messages to subscriber devices coupled to the broadband interface module.

8. A method implemented in a communications network central device for detecting a lock-up condition of a broadband interface module that includes a physical layer interface component, comprising:
step for monitoring upstream channels coupled to the broadband interface module to obtain metrics corresponding to traffic signals received at the broadband interface module;
step for evaluating the obtained metrics to determining whether traffic received over the monitored channels indicates that the broadband interface module is locked-up; and
step for resetting portions of the interface module according to an escalating maintenance routine if evaluating the metrics indicates that the broadband interface module may be locked up.

9. The method of claim 8 wherein the step for evaluating includes:
step for sending a PING message toward subscriber devices coupled to the broadband interface module; and
step for calling the escalating maintenance routine based on whether an acknowledgement is received from at least one of the subscriber devices coupled to the upstream channel in response to the PING message.

10. The method of claim 9 wherein PING messages are transmitted toward subscriber devices in a round robin fashion according to a round robin counter.

11. The method of claim 10 wherein the round robin counter is incremented for each subscriber device to which a PING message is sent.

12. The method of claim 8 wherein the step for evaluating includes:
step for sending a PING message toward subscriber devices coupled to the broadband interface module; and
step for calling the escalating maintenance routine based on whether an acknowledgement is received from at least one of the subscriber devices coupled to the upstream channel in response to the PING message, and based on the amount of traffic data that has been transmitted over the monitored channel.

13. The method of claim 8 wherein the level of corrective maintenance increases with each iteration of the escalating maintenance routine.

14. A method of detecting a lock up condition of a CAM card in a CMTS and performing corrective maintenance thereon, wherein the method is embodied in computer code that interoperates with the CMTS, comprising:
step for initiating and operating a timer function, after which expiration thereof a routine for detecting a lock up condition is called;
step for acquiring information related to traffic activity between the CAM card and subscriber devices coupled thereto, and associating metrics with the information;
step for evaluating the metrics to determine whether a lock up condition exists on one or more upstream channels served by the CAM card; and
step for determining corrective maintenance to be performed to the CAM card based on the evaluation of the metrics.

15. The method of claim 14 wherein the step for acquiring information related to traffic activity includes using a round robin counter to sequentially send PING messages to the subscriber devices.

16. The method of claim 14 wherein the step for determining corrective maintenance includes an escalating maintenance routine wherein the level of corrective maintenance increases with each iteration of the escalating maintenance routine.
